(19) United States
(12) Patent Application Publication
(10) Pub. No.: US 2007/0260578 A1
(43) Pub. Date: Nov. 8, 2007

(54) Pivot table without server side on-line analytical processing service

(75) Inventor: Dipanjan Ghosh, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/418,216

(22) Filed: May 4, 2006

(51) Int. Cl. G06F 17/30

(52) U.S. Cl. 707/2

(57) ABSTRACT

A method and apparatus are discussed that allow the user to view advanced data-based pivot tables in spreadsheet or other database accessing programs from any relational database without requiring a server side on-line analytical processing (OLAP) service in place. To obtain this degree of freedom a temporary multidimensional file is created on the local machine that is a snapshot of the data currently in the relational database. The pivot tables then interact with this temporary file to provide the data to the user.

### BACKGROUND

In today's business environment it has become commonplace for users to interact with data stored in a database. Due to the vast amounts of information stored in these databases they often contain information that is useful to the user as well as information that is not useful to the task the user is currently performing. These databases are typically relational databases that provide a multitude of different independent variables or dimensions. Further, these databases are often kept on a server and accessed by a large number of users. Each of these users may be performing different functions on the data in the database. For example, one user may be accessing data from the database while another user is entering new data into the database. This constant accessing of the database can place a strain on the connection between a user and the server.

Users needing to only view or obtain information from the database often have the requirement of observing the variation or pattern of data over multiple dimensions as a cumulative effect. This is known as multidimensional analysis and the resulting data can be represented by a cube structure. Multidimensional analysis often produces detailed data such that it may have different levels of summarization for the constituting dimensions. For example, the user may want all customers who have bought a certain item over a certain date range. Then, when the results are obtained, the user needs to view these results in a convenient form. This data can be viewed as a multidimensional cube representing sales figures over these three independent dimensions: Date, Item and Customers. The user can then obtain orthogonal comparisons of sales values between different items, between different customers and for different dates. In addition, the hierarchal organization of different dimensions (e.g. by Year/Quarter/Month/Day for the Date dimension) provides different levels of quick aggregation of data.

Pivot tables provide a convenient format to view the results returned from this multi-dimensional analysis of the database. Among the different types of pivot tables, the most advanced are those based on the OLAP data. These types of tables can have hierarchies in dimension and can provide a summarized view of the data at any level of the hierarchy. Though spreadsheet programs provide a connection procedure to the server side OLAP data, there currently is no direct way to show the result of a multidimensional analysis performed on live data stored in a relational database. Since the OLAP services are generally not included in the features of lower complexity database packages often used by small or mid-market applications, the users of those applications are deprived of leveraging the power that pivot tables (also referred to as pivot charts) to gain better business insights along different operational metrics or dimensions. The user often does not have access to the analysis services of the related relational database.

The discussion above is merely provided for general background information and is not intended to be used as an aid in determining the scope of the claimed subject matter.

### SUMMARY

Embodiments are provided that allow the user to view advanced data-based hierarchical dimensions in spreadsheet programs or other database accessing programs from any relational database without requiring a server side OLAP service in place. To obtain this degree of freedom a one-time multidimensional analysis is performed locally to obtain data with the largest possible details across all dimensions from a snapshot of data currently present in the relational database. The result is in one embodiment a cube file that is stored in a temporary file. The pivot tables then interact with this temporary file to provide the data to the user.

A second embodiment is directed to refreshing the temporary file during normal operations. The first step of the process is to temporarily remove the connection between the file and the associated pivot table. Once the connection has been removed, the process builds the connection string and connection object between the file and the relational database. Then, the system accesses the relational database by opening a connection between the temporary file and the database. While the connection is open, the system performs the multidimensional analysis once again on the snapshot of data present in the relational database and updates the temporary file with the result of analysis. Then, the database connection is closed and the connection between the temporary file and the associated pivot table is recreated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one computing environment in which some embodiments may be practiced.

FIG. 2 is a system diagram illustrating the components for interfacing with a multidimensional OLAP cube according to one embodiment.

FIG. 3 is a flow diagram illustrating the steps associated with generating the multidimensional OLAP cube.

FIG. 4 is a flow diagram illustrating the steps associated with refreshing the multidimensional OLAP cube according to one embodiment.

### DETAILED DESCRIPTION

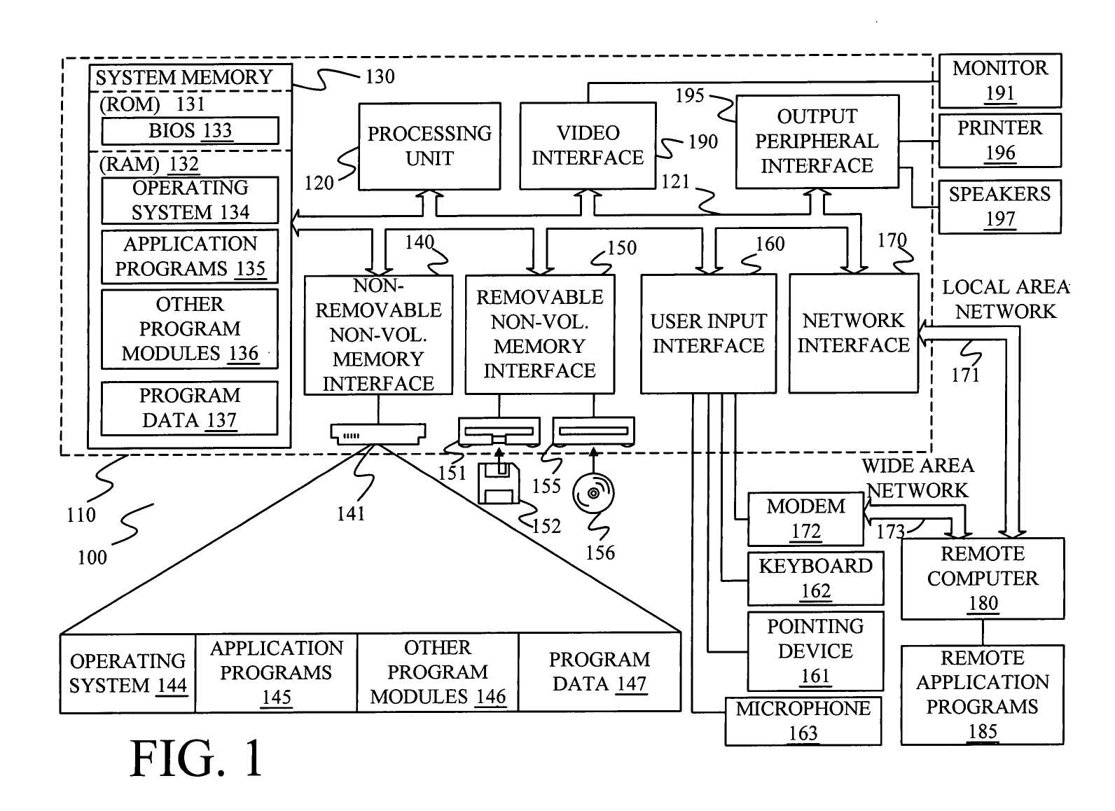

FIG. 1 illustrates an example of a suitable computing system environment 100 on which embodiments may be implemented. The computing system environment 100 is only one example of a suitable computing environment and is not intended to suggest any limitation as to the scope of use or functionality of the claimed subject matter. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

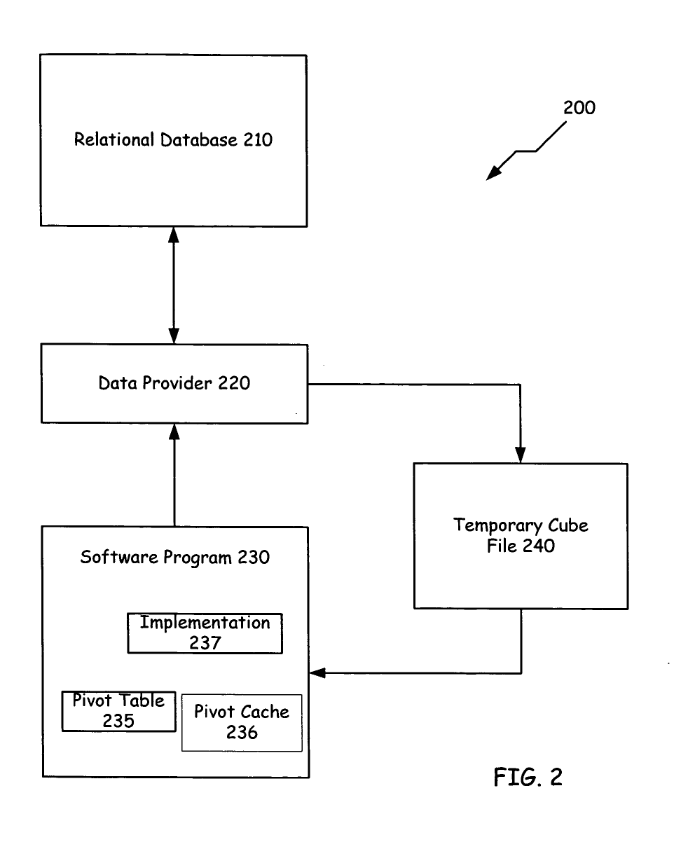

FIG. 2 is a system diagram illustrating a system 200 according to one embodiment. System 200 illustrates a relational database 210, a data provider 220, a software program 230 and a local database 240.

In the embodiment of FIG. 2, temporary cube file 240, which is a snapshot of the date in relational database 210 can be used to allow the user of a spreadsheet program the a

The relational database 210 is in one embodiment a Sequential Query Language (SQL) database. However, other types of relation databases can be used. The relational database is located remotely from the rest of the components in system 200. In some embodiments the relational database is accessible through a LAN connection. However, in other embodiments the relational database can be accessed through the internet or any other protocol that allows remote access to the database 210.

In general a relational database is a database that is structured in accordance with a relational model. Strictly speaking the term refers to a specific collection of data but it can be used to identify the software used to manage the collection of data. In a relational database all data is stored and retrieved from a relational database is cast in the form of relations. The database is divided into attribute values or feature values. These are identified by means of attribute names or feature names. Queries and integrity constraints are expressed declaratively, without the use of iterative loops or pointers, using operators based on relational algebra and relation comparisons. The relational algebra is a set of operations that manipulate relations as they are defined in the relational model and as such describes part of the data manipulation aspect of this data model. Because of their algebraic properties these operations are often used in database query optimization as an intermediate representation of a query to which certain rewrite rules can be applied to obtain a more efficient version of the query. The exact set of operations may differ per definition and also depends on whether the unlabeled relational model (that uses mathematical relations) or the labeled relational model (that uses the labeled specialization of mathematical relations) is used.

The data provider 220 is protocol or module that allows the transmission of data between two components of a software program. The data provide can be language-independent and can include built-in interprocess communications capability as well as working well within object-oriented program designs. In one embodiment the data provider 220 is an ActiveX Data Object Multidimensional (ADOMD) data provider. However, other types of multidimensional data providers can be used depending on the configuration of system 200 and the associated software 230. For the sake of the present example, the ActiveX embodiment will be discussed herein. The data provider 220 accesses the database 210 and provides to the software program the requested data. Further, the data provider assists in the population of the temporary file 240.

ActiveX Data Objects (ADO) are a component object model (COM) object for accessing data sources. The model provides a layer between programming languages and the database. This allows a developer to write programs to access data in the database, without having to know how the database is implemented or structured. Through the use of ADOs, the system is only required to have knowledge of the database for connection only. ADOs can be used to execute arbitrary commands that are available in the structures used in the database. ADOs are dependent upon the database.

Another type of ActiveX Data Objects is ADO.NET. ADO.NET is the primary relational data access model for accessing NET-based applications. It can be used to access data sources for which there is a specific NET Provider, or, via a .NET Bridge Provider, for which there is a specific OLE DB Provider, ODBC Driver, or JDBC Driver. ADO.NET includes of two primary parts: the data provider and the data set. Another version of ADO and ADO.NET is ADO-multidimensional (ADOMD). ADOMD supports multidimensional analysis and data access across application.

The data providers 220 are object classes. These classes provide access to and communicate with a database, such as a SQL Server database 210 discussed above. Each database has its own set of provider objects, but they each have a common set of suffixes to ensure that the data can be read from the database. For example, two object types in the data providers are provided for illustrative purposes. However, there are significantly more objects available. Connection objects provide a connection to the database, needed to access it. They also act as an abstract factory for command objects. Command objects are used to perform some action on the database, such as reading, updating, or deleting relational data.

The data set objects are a group of classes describing a simple in-memory relational database. A data set object represents an entire database. It can contain tables and relationships between those tables. A data table object is a dataset object that represents a single table in the database. It has a name, rows, and columns. These features also have associated data objects in the data set. A data relation is a relationship between tables, such as a primary-key foreign-key relationship. This is helpful for enabling the functionality of retrieving related rows in a relational database.

Depending on the configuration of the system 200 the data provider 220 can in some embodiments use ADOMD or ADOMD.NET. However, other interfaces can be used. Additional embodiments can use other data provider protocols that allow the software program 230 to interface with the relational database 210 and perform multi-dimensional analysis.

Software program 230 is a program that is configured to interface with a relational database, such as relational database 210. The software program can be a spreadsheet program, such as Microsoft® Excel. However, any program interfacing or using data in a relational database can be used. In various embodiments, the software program 235 makes use of pivot tables 235. The pivot tables 235 may have an associated pivot cache 236 for holding information related to the pivot table. The pivot table interfaces with user through the use of an implementation protocol 237. These protocols can be any known method for implementing the software program and the pivot tables.

For example, in Microsoft Excel, pivot tables, such as pivot table 235, provide a convenient method to view the results returned from a multi-dimensional analysis. There are many different types of pivot tables 235 that can be used in the present embodiments, and the description contained herein is not limited to any one particular type of pivot table. One of the types of pivot tables that the present exemplary embodiments use is based on on-line analytical processing (OLAP) system data. These types of tables often have hierarchies in the dimension, and can provide a summarized view of the data at any level of the hierarchy. For example, Microsoft Excel provides an easy connection procedure to server side OLAP cubes. In this embodiment the OLAP cubes are created and maintained by an OLAP server such as the Microsoft Analysis Services for SQL Server 2000. However, there is no direct way to show the result of a multidimensional analysis performed on live data stored in a relational database. Since the OLAP services are generally not included in the SKU of database packages used by small or mid-market applications, the users of those applications are deprived of leveraging the power of Excel pivot tables or pivot charts.

In some small business accounting systems, a booking process is provided that collects detailed sales data for the company. This date is often kept for a period of time, such as a year, so that the company can review various components of transactions. Other software programs not used for accounting systems often employ similar long term data histories that may be reviewed by the users. For an example, the Microsoft Small Business Accounting 2006 (SBA) program is based on the Microsoft Desktop Engine (MSDE) database systems. As part of its bookkeeping process, the application collects detailed sales data of the company round the year. This data can be viewed as a multidimensional cube representing sales figures over three independent dimensions. For example by Date, Item and Customers. When viewed this way the user gets powerful orthogonal comparisons of sales values between different items, between different customers and for different dates. Not only this, the hierarchal organization of different dimensions (e.g. by Year/Quarter/Month/Day for Date dimension) provides different levels of quick aggregation of data. In many of these small business accounting systems, the user does not have complex database analysis capability. Therefore, the user does not have a way to view sales data updates, that are current up to the moment figures, in a pivot table or pivot chart such as the ones discribed above.

Temporary file 240 is a file used to hold a snapshot of the data that is contained in the relational database 210. The temporary file 240 acts as a buffer between the pivot table 235 and the relational database 210. This way it is not necessary to perform server side processing of the OLAP data. This results in a more efficient interaction with the data. In one embodiment the temporary file 240 is a multidimensional OLAP cube. However, other types of temporary files can be used. In various embodiments the temporary file 240 contains the results of a multidimensional analysis on the relational database.

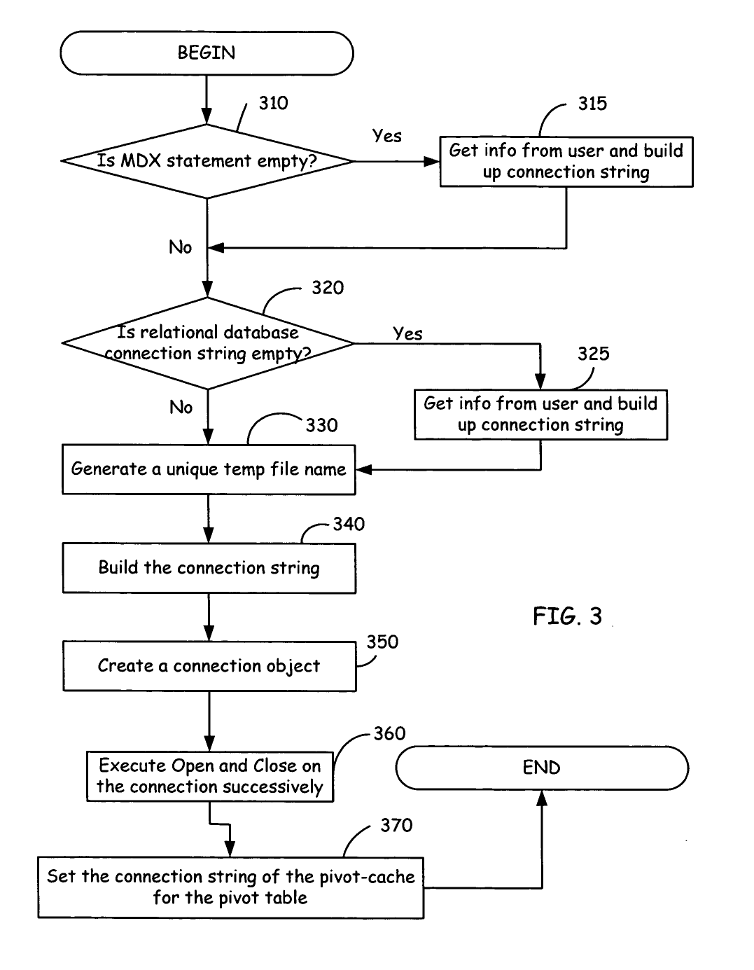

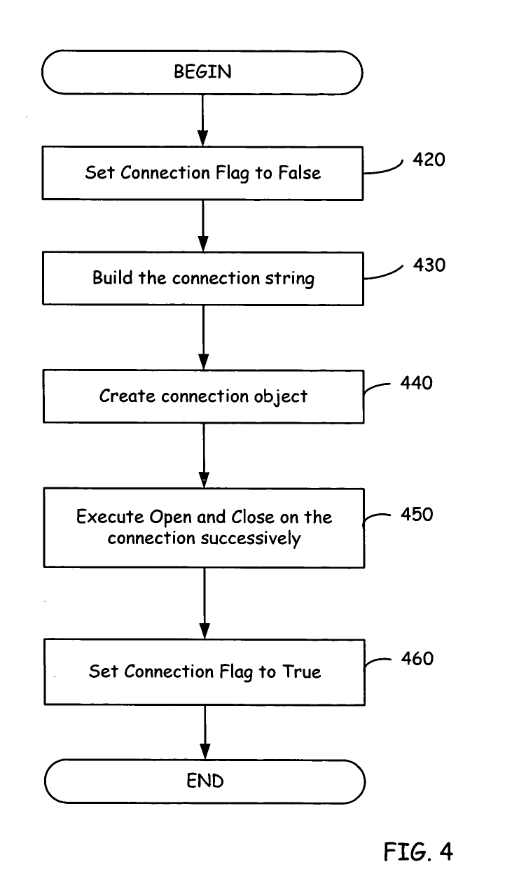

To obtain this file 240 a protocol is followed. The details of the protocol are discussed in greater detail with regards to FIGS. 3 and 4. The file 240 is defined by a series of connection strings and a multidimensional statement. These definitions allow the associated software program obtain the necessary data from the relational database 210. At any time during the use of the temporary file 240 the user or the software program 230 can refresh the data to ensure that the most current data is being used.

Decision support systems have been developed to efficiently retrieve selected information from data warehouses, such as relational database. One example of a decision support system is known as an on-line analytical processing system (“OLAP”). In general, OLAP systems analyze the data from a number of different perspectives and support complex analyses against large input data sets.

There are at least three different types of OLAP architectures, which can be used as the decision support system for retrieving information from a data warehouse. These include, ROLAP, MOLAP, and HOLAP. ROLAP (“Relational On-Line Analytical Processing”) systems are systems that use a dynamic server connected to a relational database system. Multidimensional OLAP (“MOLAP”) utilizes a proprietary multidimensional database (“MDDB”) to provide OLAP analyses. The main premise of this architecture is that data must be stored multidimensionally to be viewed multidimensionally. A HOLAP (“Hybrid On-Line Analytical Processing”) system is a hybrid of these two.

ROLAP is a multi-tier, client/server architecture comprising a presentation tier, an application logic tier and a relational database tier. The relational database tier stores data and connects to the application logic tier. The application logic tier comprises a ROLAP engine that executes multidimensional reports from multiple end users. The ROLAP engine integrates with a variety of presentation layers, through which users perform OLAP analyses. The presentation layers enable users to provide requests to the ROLAP engine. The premise of ROLAP is that OLAP capabilities are best provided directly against a relational database, e.g., the data warehouse.

In a ROLAP system, data from transaction-processing systems is loaded into a defined data model in the data warehouse. Database routines are run to aggregate the data, if required by the data model. Indices are then created to optimize query access times. End users submit multidimensional analyses to the ROLAP engine, which then dynamically transforms the requests into SQL execution plans. The SQL is submitted to the relational database for processing, the relational query results are cross-tabulated, and a multidimensional result set is returned to the end user. ROLAP is a fully dynamic architecture capable of utilizing precalculated results when they are available, or dynamically generating results from atomic information when necessary.

The ROLAP architecture directly accesses data from data warehouses, and therefore supports optimization techniques to meet batch window requirements and to provide fast response times. These optimization techniques typically include application-level table partitioning, aggregate inferencing, denormalization of data structures, multiple fact table joins, and the use of specific RDB optimizer tactics which vary with each particular brand of relational database.

MOLAP is a two-tier, client/server architecture. In this architecture, the MDDB serves as both the database layer and the application logic layer. In the database layer, the multidimensional database (MDDB) system is responsible for all data storage, access, and retrieval processes. In the application logic layer, the MDDB is responsible for the execution of all OLAP requests. The presentation layer integrates with the application logic layer and provides an interface through which the end users view and request OLAP analyses. The client/server architecture allows multiple users to access the multidimensional database.

Information from a variety of transaction-processing systems is loaded into the MDDB System through a series of batch routines. Once this atomic data has been loaded into the MDDB, the general approach is to perform a series of batch calculations to aggregate along the orthogonal dimensions and fill the MDDB array structures. For example, revenue figures for all of the stores in a state would be added together to fill the state level cells in the database. After the array structure in the database has been filled, indices are created and hashing algorithms are used to improve query access times.

Once this compilation process has been completed, the MDDB is ready for use. Users request OLAP reports through the presentation layer, and the application logic layer of the MDDB retrieves the stored data.

The MOLAP architecture is a compilation-intensive architecture. It principally reads the precompiled data, and has limited capabilities to dynamically create aggregations or to calculate business metrics that have not been precalculated and stored.

The hybrid OLAP (“HOLAP”) solution is a mix of MOLAP and relational architectures that support inquiries against summary and transaction data in an integrated fashion. The HOLAP approach enables a user to perform multidimensional analysis on data in the MDDB. However, if the user reaches the bottom of the multidimensional hierarchy and requires more detailed data, the HOLAP engine generates an SQL statement to retrieve the detailed data from the source relational database management system (“RDBMS”) and returns it to the end user. HOLAP implementations rely on simple SQL statements to pull large quantities of data into the mid-tier, multidimensional engine for processing. This constrains the range of inquiry and returns large, unrefined result sets that can overwhelm networks with limited bandwidth.

As described above, each of these examples of OLAP systems are typically client-server systems. The OLAP engine resides on the server side and a module is provided at a client-side to enable users to input queries and report requests to the OLAP engine. Current client-side modules are stand alone software modules that are loaded on client-side computer systems. However, these have been used in the past for interface with the relational database only. The data provider 220 of the embodiments allows the user or system to interface and compliment the server sided OLAP engine on the client side computer system. The above description of the various types of OLAP is provided for reference.

FIG. 3 is a flow diagram illustrating the steps executed when populating the temporary OLAP cube 240 of FIG. 2 above. The following discussion is based on the steps executed while using the software program Microsoft Excel. Thus the terms used and specific processes described that are unique to Microsoft Excel are provided for illustrative purpose. Those skilled in the art will readily recognize and understand that there are comparable processes on other software programs that can easily be substituted for the present descriptions and the present embodiments are not limited to any one software program or protocol.

In one embodiment the process of populating the OLAP cube 240 is performed by executing a protocol called PivottableOpen( ). However, this protocol can have other names. In one embodiment this protocol is called when the associated Excel workbook containing the pivot table 235 first opens. However, it can be called at other times. For example, the WorkBook_Open command is one command that can be used to call the PivottableOpen protocol.

The first step of the protocol is to determine if a multidimensional expression (MDX) statement is empty. This is illustrated at step 310. To determine if the MDX statement is empty the protocol checks to see if the related string has been stored in the workbook. If the string has not been previously defined for the workbook the user is prompted to enter in the appropriate MDX statement. This is illustrated at step 315. In one illustrative embodiment, the user would input the following example statement as the MDX statement.

CreateCube=CREATE CUBE [OCWCube] (
DIMENSION [Date], LEVEL [Year], LEVEL

[Quarter],

DIMENSION [Item], LEVEL [Item Name],
DIMENSION [Vendor], LEVEL [Vendor Name],
MEASURE [Purchase in Dollars] FUNCTION SUM,
MEASURE [Purchase Units] FUNCTION SUM);

InsertInto=“INSERT INTO OCWCube(
[Item Name],
[Vendor Name],
[Year],
[Quarter],
[Purchase in Dollars],
[Purchase Units])
OPTIONS ATTEMPT_DEFER, ATTEMPT_ANALYSIS

However, other statements can be used. These statements, in some embodiments, are dependent upon the specifics of the data provider 220 that is being used.

Once the protocol has determined that the MDX statement has been filled the connection between the relational database is checked. This is illustrated at step 320. This check includes, in one embodiment, determining if a relational database connection string is empty. If the relational database string is empty the protocol requests from the user information related to the connection and builds a connection string. This is illustrated at step 325. If the string is not empty the protocol proceeds to step 330.

At step 330 the protocol generates a file name for the cube 240. In one embodiment this file name is a unique file name. However, it is not necessary that the file name be unique. The uniqueness of the file name helps reduce the possibility that the file would be read or modified by other programs or workbooks currently being used by the user. Additionally, in some embodiments the cube file has its own unique file extension. In one illustrative embodiment the cube file has a cub file extension. However, this file extension nomenclature is not necessary and any file extension can be used.

Next the protocol builds a Multidimensional Data Object(MDO) connection string. This is illustrated at step 340. In one embodiment this MDO is an ActiveX Data Object Multidimensional (ADOMD). However, other multidimensional data objects can be used. Further, when other typs of data provides 220 are used, the connection string is in the format required by the data provider 220. This process can be broken down into three components, which for purposes of simplicity are not all illustrated in FIG. 3. First, the relational database string is identified. This can be represented by coding the connection string as SOURCE_DSN. The second step to formulation is the MDX query. The MDX query is the query used to access the relational database to obtain the desired data for the OLAP cube 240. Third, the path name assigned to the temp OLAP file 240 is designated as the LOCATION in the ADOMD connection string.

Once the ADOMD connection string has been built the protocol proceeds to create a connection object. In one embodiment, the connection object is an ActiveX Object Database (ADODB) connection object. However, other connection objects can be used. This is illustrated at step 350. At this step the protocol uses the ADOMD connection string built at step 340 above, and designates the PROVIDER protocol to interface with ADOMD. In one embodiment the PROVIDER is the Microsoft OLAP (MSOLAP) protocol. However other OLAP protocols can be used for the PROVIDER.

Once the connection string and the connection object have been built or created the protocol executes a command to populate the temporary file 240. This is illustrated at step 360. In one embodiment the protocol executes an open and close operation successively on the connection with the relational database 210.

This open and close operation allows the protocol to access the relational database 210 to obtain the data. In one embodiment, this creates a temporary local OLAP cube file 240 having a snap-shot of the data available from the relational database 210 at that point. Once the data has been obtained by the protocol it is stored in the multidimensional temporary file 240. Then the connection to the relational database 210 is closed. This closure ensures that the subsequent communication between the software program 230 and the associated data is with the temporary file 240 and not with the relational database 210. However, other methods of populating the temporary file 240 can be used.

Following the population of the temporary file 240 with the data the protocol proceeds to set the connection string of the pivot cache 236 for the pivot table 235. This is illustrated at step 370. In one embodiment the connection type for the connection string is set as OLEDB. The PROVIDER is set as MSOLAP and the DATA SOURCE is set as the path name designated for the temporary file 240 at step 330.

FIG. 4 is a flow diagram illustrating the steps executed when the user or the software program 230 decides to refresh or otherwise update the temporary file 240. Several of the steps outlined in FIG. 3 above are used during the refresh or update of the temporary file 240. This protocol can be called to update the pivot-table 235 with the most recent snap shot of the data available on the relational database 210. In one illustrative implementation, an event-handler can be used for the ‘Refresh Data’ button on the Excel ‘Pivot Table’ tool bar to call this protocol. This protocol re-creates the local temporary cube file 240 and allows the pivot table 235 to connect to the updated temporary cube file 240.

The first step of the protocol is to set a connection flag on the pivot table 235 to false. This is illustrated at step 420. In one embodiment the flag is designated in the pivot cache 236 as MaintainConnection. By setting the flag to false the pivot table 235 does not access the temporary file 240 during the period of refresh. This has the effect of releasing the connection between the software program 230 and the temporary file 240.

Once the connection has been released the connection string is built. This is illustrated at step 430. In one embodiment the connection sting is built similarly to the ADOMD connection string built in step 340 of FIG. 3 above. Then the connection object is created again. This is illustrated at step 440. The process used for the creation of the connection object at this step is similar to the process used to originally create the connection object at step 350 in FIG. 3.

Following the creation of the connection string and the connection object, the refresh protocol opens and closes the connection to the relational database 210. This is illustrated at step 450. This process is similar to the process discussed above at step 360. In essence the process creates the snapshot of the data currently in the relational database 210.

Once the temporary file 240 has been refreshed, the connection flag is changed to true. This is illustrated at step 460. In the embodiment discussed herein this flag is identified by the MaintainConnection setting in the pivot cache 236. This flag allows for the reconnection of the pivot table 235 with the updated temporary cube file 240.

The multidimensional analysis is performed on the local machine using an available OLAP data provider. System builds a connection object using the data-provider and the other definitions mentioned above. The temporary file name is set as the sink or target of the connection so that result of data analysis performed through this connection gets stored into the file. Next the system opens the connection, performs the desired multidimensional analysis operation and closes the connection. Finally, the pivot table and its associated pivot cache are set to point to this temporary file as their data-source. The user then proceeds to interact with the pivot table to obtain different views of data with respect to different dimension variables present in the associated relational database.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of generating a local version of a portion of a relational database on a machine based on an analysis of a multidimensional relational database comprising the step of:
generating (330) a multidimensional temporary file on the local machine;
accessing (340, 350) a relational database to obtain data;
populating (360) the temporary file with the obtained data from the relational database; and
setting (370) a connection between the temporary file and a software program.

2. The method of claim 1 wherein the software program makes use of pivot tables.

3. The method of claim 1 wherein generating a temporary file further comprises:
building a connection string for the temporary file.

4. The method of claim 3 wherein the connection string is an ActiveX Data Object MultiDimensional.

5. The method of claim 3 wherein generating a temporary file further comprises:
creating a connection object for the temporary file.

6. The method of claim 5 wherein the connection object is an ActiveX Data Object Database.

7. The method of claim 1 further comprising:
determining in if a statement defining the temporary file is empty; and
if the statement is empty:
obtaining the statement from another source.

8. The method of claim 7 further comprising:
determining if a relational database connection string is empty; and
if the string is empty:
obtaining information from another source; and
building a connection string for the relational database.

9. The method of claim 1 wherein the temporary file is a multidimensional file.

10. The method of claim 9 wherein the temporary file is an on-line analytical processing system multidimensional file.

11. A method of refreshing a multidimensional temporary file containing a snapshot of data contained in a multidimensional relational database on a remote server, comprising:
releasing a connection between the temporary file and an associated software program (420);
obtaining from the relational database an updated version of the snapshot of data currently designated for the temporary file(450); and
reconnecting the connection between the temporary file and the associated software program(460).

12. The method of claim 11 wherein obtaining from the relational database further comprises:
building a connection string for the temporary file; and
creating a connection object for the temporary file.

13. The method of claim 12 wherein the connection string is a multidimensional object.

14. The method of claim 12 wherein the connection object is an ActiveX Data Object Database.

15. A system for interfacing with data in a multidimensional relational database located remote from the system comprising:
a software program (230);
a multidimensional temporary file (240); and
a data provider(220) configured to provide connectivity between the software program, the relational database and the temporary file.

16. The system of claim 15 wherein the temporary file is a multidimensional on-line analytical processing (MDXOLAP) file.

17. The system of claim 16 wherein the MDXOLAP file is a cube file.

18. The system of claim 15 wherein the software program further comprises:
at least one component configured to operate as a pivot table; and
wherein the pivot table is configured to obtain data from the temporary file.

19. The system of claim 15 wherein the data provider is an ActiveX Data Object Multidimensional (ADOMD) data provider.

20. The system of claim 15 wherein the multidimensional relational database is a Sequential Query Language Database.
